(19) United States
(12) Patent Application Publication
(10) Pub. No.: US 2005/0068156 A1
(43) Pub. Date: Mar. 31, 2005

(54) [RELIABLE METHOD OF DETERMINING TAG BINARY IDENTIFICATIONS]

(76) Inventors: Chow-Chin Chuang, Taipei City (TW); Chi-Yuan Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,297

(22) Filed: Dec. 4, 2003

(30) Foreign Application Priority Data
Sep. 30, 2003 (TW) 92126942

(51) Int. Cl. G08C 19/00

(52) U.S. Cl. 340/10.2; 340/5.72; 340/10.1

(57) ABSTRACT

A method of determining tag identifications is discloses. The method comprises: providing an index signal; receiving a responsive signal generated from tag matching the index signal; obtaining an identification code corresponding to the responsive signal; reader sending an acknowledgement and waiting for tag to respond a returned-acknowledgement. A searching process is repeated at the current node after a tag responsive signal is received to prevent signal suppression errors.

### CROSS REFERENCE TO RELATED APPLICATIONS

This application claims the priority benefit of Taiwan application serial no. 92126942, filed Sep. 30, 2003.

### BACKGROUND OF INVENTION

1. Field of the Invention

This invention is an addendum and enhancement to the binary tree based tags identification method. There are scenarios which will cause failures for the binary tree based tag identifications searching method. The proposed invention is aimed to correctly receive tag identifications under these scenarios.

2. Description of the Related Art

In a society where processing efficiency is admired, any method capable of reducing the time required to complete a task is in great demand. For a business group that has to control the shipment of many products to customers, an increase in efficiency means more work can be completed by the same number of people within a given time period. In other words, with an increase in processing efficiency, more people can be assigned to manage shipment and control stock level at any one time.

To increase processing efficiency, two major product identification systems, namely, the barcode system and the radio frequency identification (RFID) or electronic tagging system are in use. Among the two product identification systems, although the barcode system is easier to use, the first pass read accuracy is at most 95%˜98%. In some adverse conditions, the first pass red accuracy may dip to as low as 90%. In comparison, although the radio frequency identification system demands the presence of a few simple circuits to serve as data storage media, the first pass read accuracy is as high as 99.5% or even 100%. With the convenience provided by a high processing efficiency, the conventional barcode system is gradually replaced by the radio frequency identification system. However, because the tag identifications transmitted by electromagnetic waves can be interfered by external noises, tags collisions or tags signals suppression. Thus, with these scenarios, the tags identifications search method can falsely claim detection of non-exist tag identification or leave existing tags undetected.

### SUMMARY OF INVENTION

The objective of the present invention is to provide a reliable method of determining tags identifications without causing incorrect results.

First of all (refer to the binary tree based tags identification search method), after a tag identification is received from a tag, the proposed invention will add acknowledgement messages between tag and reader to confirm the tag identification is correctly received by the reader. This confirmation process can prevent the following error scenarios when the tag identification is received by the reader: 1. The tag identification can be the result of interferences (garbling) among tags. 2. The tag identification received can be interfered by noise. A tag identification is claimed detected only when tags acknowledgement signal is received by the reader. With both garbling error and noise error, reader will not get the acknowledgement signal back from tag. So the tag identification confirmation signal resent by the reader can prevent the errors caused by these interference errors.

After a tag identification is correctly received by reader, based on the binary tree based searching method, we should mark the current node as Completed status to prevent further operation and response. However, there is a situation can leave many tags undetected under this sub-tree. When multiple tags situated under a sub-tree, because tags signals strength can be different, a tag signal can be peculiarly strong to suppress other tags signals. This can cause tags undetected error as described previously. To prevent this error to happen, an extra tag identification process is repeated for the current node. Since the tag with the strongest signal strength is detected and marked as Completed status, to repeat the search command can pick up those tags suppressed earlier.

From the descriptions mentioned above, this invention utilizes the acknowledgement signals to decide if the tag with requested identification exists or not. Therefore, the present invention can find out identification error without relying on a data base look up. Moreover, the present invention can stop the response form the detected tag and detect an tag whose signal is suppressed by the others.

In order to make the aforementioned and other objects, features and advantages of the present invention understandable, a preferred embodiment accompanied with figures is described in detail below.

### BRIEF DESCRIPTION OF DRAWINGS

FIG. 1 is a flow chart showing a preferred embodiment of the present invention.

FIG. 2 is a flow chart showing another embodiment of the present invention.

### DETAILED DESCRIPTION

Many existing tag identification methods are using non-collision based search process. Therefore, the signal interference of objects barely occurs under Radio Frequency Identification (RFID). Under the circumstances, the external noises will be the main cause interfering the identification process. For the collision based search method, the signal suppression and signal garbling can occur among tags.

Under identification collision, the garbled tag identification can be identifiable but not for any existing tag. In prior art, the issue of generating the identifiable tag identification is not resolvable. The present invention, however, can solve the problem easily.

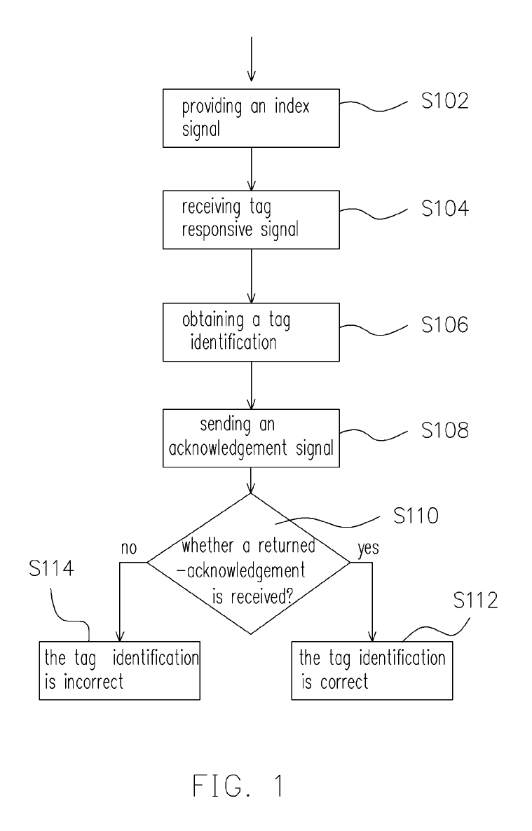

Referring to FIG. 1, a flow chart showing a preferred embodiment of the present invention is shown. First, a reader sends out an index signal (the search pattern which is the same as the tree nodes index) in step S102 and waiting for a tag responsive signal generated from the tag in step S104. Once the tag responsive signal is received and an tag identification can be found in step S106, the reader will send out an acknowledgement according to the received tag identification in step S108. In the embodiment, the acknowledgement in step S108 can make the tag return an acknowledgement to reader. Therefore, if in step S110 the returned-acknowledgement is received, it is claimed the tag is identified in step S112. Otherwise, if in step S110 the returned-acknowledgement is not received, the tag in search does not exist and the identification received is proved incorrect in step S114.

For the person having ordinary skill in the art, a time period to wait for the returned-acknowledgement generally is not limited. A pre-determined time usually is set and used as a standard for determining whether a returned-acknowledgement is received.

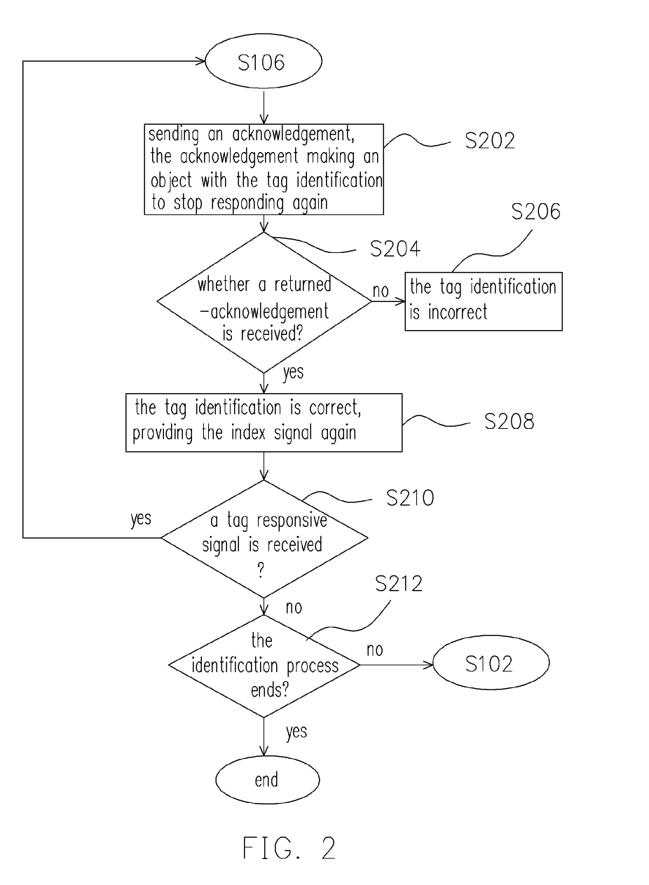

Identification suppression occurs because of difference of the tags signal strength. The distance and tags circuit characteristics will make the signal strength different. The strongest tag signal will overpower other tags signals and may confuse reader that it is the only tag situated in the current sub-tree. In order to resolve the signal suppression case, this invention discloses another preferred embodiment for the method of determining tag identifications. Referring to FIG. 2, a flow chart showing another embodiment of the present invention is shown. In the embodiment, steps S102 and S104 are the same steps shown in FIG. 1. After the tag identification is received in step S106, reader will send an acknowledgement to the tag and waiting for tags returned-acknowledgement. The acknowledgement sent by the reader can prevent the tag from responding to further requests of the reader until the reader is reset or restarted in step S202.

If no returned-acknowledgement is received in a predetermined time, the tag identification is claimed incorrectly received shown in step S206. Otherwise, if the returned-acknowledgement is received in a pre-determined time, the tag identification is claimed correctly received. After the tag is securely identified, the tag will set to Completed status and will not respond to readers further request until reader reset or restart.

To prevent signal suppression which causes tags undetected, an search process is repeated in step S208 after the tag identification is correctly received by sending the index signal again. If there exists left over tags, one or more tag responsive signal will be received in step S210 and the flow will go to step S106 for finding out the identification code of other tags. Otherwise, signal suppression does not occur and step S212 is performed to determine whether the tag search process is complete.

It is obvious to see the huge enhancement achieved through this invention to prevent interference errors caused by noise, collision and signal suppression.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. A method of determining tag binary identifications, which comprising:
(a) a reader sending an index signal;
(b) the reader receiving a tag responsive signal associated with the index signal;
(c) the reader reads a tag identification based on the tag responsive signal;
(d) the reader sending an acknowledgement to the tag; and
(e) the tag returning a returned-acknowledgement to the reader.

2. The method of claim 1, wherein the acknowledgement makes the tag does not respond again until the reader is reset.

3. The method of claim 2, further comprising:
(f) resending the index signal after the returned-acknowledgement is received; and
(g) steps (c)˜(e) are repeated if the tag responsive signal associated with the index signal is received.

4. The method of claim 1, wherein step (e) comprises:
determining the tag identifications is correct if the returned-acknowledgement is received in a pre-determined time; and
determining the tag identification is incorrect if the returned-acknowledgement is not received in the pre-determined time.

5. The method of claim 1, wherein the tag identification is obtained from contents of the responsive signal.
